(19) United States
(12) Patent Application Publication
(10) Pub. No.: US 2019/0013656 A1
(43) Pub. Date: Jan. 10, 2019

(54) Angularly Adjustable Tubular Elbow

(71) Applicant: CCG Australasia Pty Ltd, Perth, WA (AU)

(72) Inventor: Geoffrey Ingles Mood, Tyne and Wear (GB)

(73) Assignee: CCG Australasia Pty Ltd, Perth, WA (AU)

(21) Appl. No.: 16/070,183

(22) PCT Filed: Nov. 9, 2016
(86) PCT No.: PCT/IB2016/056735

§ 371 Date: Jul. 13, 2018

(30) Foreign Application Priority Data
Jan. 14, 2016 (GB) 1600733.8

(51) Int. Cl. H02G 3/06; H02G 3/08; F16L 43/00

(52) U.S. Cl. CPC H02G 3/0633; F16L 43/00; H02G 3/083

(57) ABSTRACT

An angularly adjustable tubular elbow is provided for use in association with an electrical junction box. The elbow has an externally screw threaded male spigot at one end and a correspondingly screw threaded female socket at the other end. A locknut cooperates with the screw thread on the male spigot so as to leave usable screw thread on the male spigot that has a length at least equal to one thread pitch longer than is required for satisfying a specification or requirement. A seal that accommodates rotation of the elbow about the axis of the spigot is provided between the male spigot and the locknut to prevent ingress of moisture or other unwanted fluids along the thread. The elbow can be installed with the locknut fully retracted, followed by rotation of the elbow by no more than 360° to align the female socket and subsequently tightening the locknut.

### CROSS-REFERENCE(S) TO RELATED APPLICATIONS

This application claims priority from United Kingdom patent application number 1600733.8 filed on 14^{th} Jan. 2016, which is incorporated by reference herein.

### FIELD OF THE INVENTION

This invention relates to an angularly adjustable tubular elbow of a type that can, especially, but not exclusively, be used in conjunction with electrical cables, cable glands and associated junction boxes. Use of such an elbow enables a cable, that may be an armoured cable and therefore rather stiff, to be installed in close proximity to an object that would, in the absence of the elbow, obstruct the cable gland and/or a cable passing through it if it were to extend out of a side wall of the junction box in the usual perpendicular or radial direction. Such a junction box may be of a conventional square shape or of a circular shape when viewed along a central axis of the junction box.

### BACKGROUND TO THE INVENTION

A 90° tubular elbow can be used in cable wiring applications in which space is restricted and there is insufficient room to fit a conventional cable gland together with a cable passing through it. The cable must describe an arc having a radius which is dependent on the stiffness of the cable. The 90° elbow enables a cable gland to be mounted with a fixed axis extending in the usual perpendicular or radial direction and its free axis that is at right angles to the fixed axis at right angles to the usual radial or perpendicular direction. The relatively flexible inner conductors of a cable can then pass through the 90° elbow to enter the interior of the junction box or other housing.

The equipment to which the 90° elbow is to be fitted may have a mounting hole which is either a plain hole (if the equipment has a thin wall) or a threaded hole or fixed nut. If the elbow is fitted to a plain hole then it may be secured using a locknut and it can be positioned with its free axis extending in whatever direction is required.

However, if the mounting hole is threaded or has a fixed nut, in the absence of any specific provisions, an elbow may be fully tightened and will probably end up with its free axis extending in the wrong direction. Alternatively, it may be positioned with its axis extending in the required direction, but will not be fully tightened. As a further alternative, installers may be tempted to over-tighten the elbow until its axis extends in the required direction.

In some applications, the elbow may be used for wiring in a potentially explosive atmosphere and will then be subject to regulations prescribing the number of threads that need to be engaged and/or an ingress protection (IP) rating.

As a consequence, special 90° elbows for use in potentially explosive atmospheres have been designed and allow the elbow to be fitted and positioned with its free axis extending in the desired direction. These elbow designs need to have a means for preventing an explosion from passing from the equipment to which it is attached, to the outside atmosphere by way of what is known as a flamepath.

In a first such design the flamepath passes between two closely adjacent surfaces of a tube integral with the externally screw threaded spigot connecting it to the junction box and a relatively rotatable coaxial outer tube that is integral with a screw threaded socket for receiving a cable gland. The elbow is of a significant size and the cable is therefore not mounted as close to the equipment as would be desirable.

A second design has an annular radially serrated flamepath in which two relatively rotatable components have flanges with a series of concentric inter-engaging ridges providing the flamepath. The two flanges are held together by a union nut urging them towards each other with the ridges inter-engaging. This design can be made more compact than the first design but it is complicated and therefore costly to manufacture.

A third design is an elbow having a thin locknut on its male thread. The elbow can be tightened as far as possible and then slackened until its free axis extends in the desired direction and the locknut may then be tightened to secure the elbow in its desired position. The drawback with this solution is that an installer would not have any indication that he had failed to engage enough threads to satisfy the requirements for explosive atmospheres and the assembly may not have the required IP rating as water may be able to creep along the threads. In this instance the engaged threads form the required flamepath.

There is a need therefore for a simple and easy to install elbow that is compact, adjustable and simple to manufacture.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with this invention there is provided an angularly adjustable tubular elbow comprising an elbow having an externally screw threaded male spigot at one end and a correspondingly screw threaded female socket at the other end and wherein a locknut cooperates with the screw thread on the male spigot leaving usable screw thread on the male spigot that has a length at least one thread pitch longer than is required for satisfying a specification when the locknut is screwed fully onto the male spigot to a terminal position, the locknut having an end surface nearer a free end of the male spigot that is suitable for sealing against an outer surface of a junction box either directly or indirectly by way of a sealing washer and wherein a seal on the locknut or male spigot or both serve to seal the screw thread of the male spigot and the locknut against the passage of moisture or other fluids along the thread.

In a first variation of the invention the locknut has a coaxial annular extension extending in a direction away from the free end of the screw threaded male spigot and the elbow has, interposed between the male spigot screw thread and the elbow itself, a cylindrical surface directed radially outwards and coaxial with the male spigot with the cylindrical surface being located radially opposite a cooperating sealing surface on the annular extension to the locknut with the seal being in the form of a sealing ring interposed between two sealing surfaces to effectively seal the surfaces together for at least one full turn of the locknut from its terminal position.

Further features of the first variation of the invention provide for the surface on the elbow to have a groove partially accommodating the sealing ring that seals against the base of the groove and projects radially beyond an adjacent cylindrical surface in which the groove is located, the sealing ring preferably being in the form of an O-ring; and for the sealing surface on the annular extension to the locknut to be a smooth inwardly directed right circular cylindrical surface engaged by the sealing ring.

In a second variation of the invention the seal is in the form of an axially extending patch of deformable polyester or other suitable material that extends over a limited circumferential portion of the thread and typically extends along the length of the nut or screw threaded male spigot. The polyester or other material may be resilient and have high strength and may be akin to that used in normal locknuts that have a dedicated locknut application. A locknut of this type exhibits a thread seal in which the patch acts as a dam to prevent liquid leakage along the thread helix.

In a third variation of the invention the entire locknut may be made of an optionally reinforced plastic material such as a suitable nylon or the like that itself sealingly engages the male spigot screw thread. Such a plastic locknut may be reinforced by one or more endless reinforcing rings moulded into and embedded within the plastics material. In such an instance, the material from which the locknut is made is selected to create a seal with an engaged surface of a junction box

Further features of the invention that can be applied to any one of the first, second or third variations of the invention provide for the tubular elbow remote from the free end of the screw threaded male spigot to have an outwardly directed integral abutment flange that is adapted to be engaged by the locknut or any annular extension thereto in its terminal position being its most retracted position from the free end of the screw threaded male spigot; for the elbow to have two oppositely directed engagement surfaces on sides thereof for engagement by jaws of a tool whereby the elbow can be rotated about the axis of the screw threaded male spigot; for the screw threaded male spigot to be complementary to a screw thread or fixed nut associated with a junction box in which instance the screw threaded female socket is complementary to external screw threads on a screw threaded male spigot of a cable gland for fitment to the junction box by way of the tubular elbow; and for a sealing washer to be held captive relative to the locknut or male spigot for location, in use, between the locknut and an outer surface of a junction box so that no loose components are required for installation purposes.

The invention also provides a tubular elbow as defined above in combination with an electrical junction box to which it is fitted.

It will be understood that the manufacture of an elbow as defined above is simple and can be carried out on production lathe facilities currently available in modern production plants.

An embodiment of each of the first, second and third variations of the invention will now be described, by way of example only, with reference to the accompanying drawings.

### BRIEF DESCRIPTION OF THE DRAWINGS

In the drawings:

FIG. 1 illustrates in elevation a circular junction box from which a conventional cable gland extends in the normal radial direction;

FIG. 2 illustrates in similar elevation a circular junction box having a cable gland attached thereto by way of an elbow of the type with which this invention is concerned;

FIG. 3 is a plan view of a junction box of the type illustrated in FIGS. 1 and 2 and indicating possible directions in which the cable gland illustrated in FIG. 2 can be adjusted to extend whilst using an elbow as provided by this invention;

FIG. 4 is a sectional elevation of one embodiment of tubular elbow according to the present invention and illustrating its cooperation with a screw threaded female socket such as in a junction box;

FIG. 5 is a detail of the seal between the locknut and elbow;

FIG. 6 is a side elevation of the tubular elbow illustrated in FIG. 4;

FIG. 7 is an elevation of the tubular elbow illustrated in FIGS. 4 and 5 when fully screwed into a screw threaded female socket in a housing such as a junction box;

FIG. 8 is a similar elevation of the tubular elbow illustrated in FIG. 6 when adjusted such that the axis of the screw threaded female socket extends in a required direction and the locknut has been finally tightened;

FIG. 9 is a section through a locknut illustrating an embodiment of the second variation of the invention; and,

FIG. 10 is a detail of the seal between the locknut and elbow of an embodiment of the a third variation of the invention.

### DETAILED DESCRIPTION WITH REFERENCE TO THE DRAWINGS

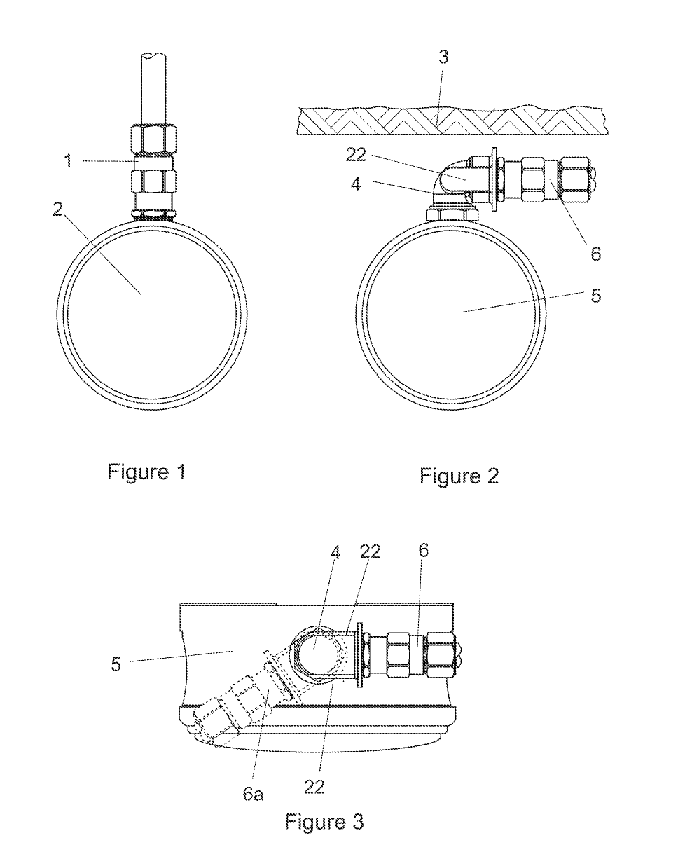

FIGS. 1 to 3 of the drawings illustrate the problem addressed by a tubular elbow of the nature provided by the invention. FIG. 1 illustrates a conventional cable gland (1) projecting radially from a circular cross-sectioned junction box (2) by having its screw threaded male spigot engaged directly in the screw threaded female socket within the junction box.

However, if there is an obstruction such as that indicated by numeral (3) in FIG. 2, there is no room for the cable gland to extend radially from the junction box and a tubular elbow (4) is interposed between the junction box (5) and the cable gland (6) so that the latter can project in a direction at right angles to the axis of the screw threaded female socket in the junction box.

As shown in FIG. 3, the required direction for the cable gland (6) illustrated in FIG. 2 is illustrated in solid lines whilst the natural direction in which it would extend if it were tightened normally without an adjustable elbow, is indicated in dotted lines (6a). As indicated above, an adjustable tubular elbow is required in order to overcome this difficulty. One embodiment of the first variation of tubular elbow according to this invention will now be described in more detail with reference to FIGS. 2 to 8 of the accompanying drawings.

In the embodiment of the invention that is illustrated in FIGS. 2 to 8, an angularly adjustable tubular elbow (4) comprises an elbow having an externally screw threaded male spigot (12) at one end and a correspondingly screw threaded female socket (13) at the other end. These screw threads are configured to correspond to those of a female screw threaded socket and to receive the screw threaded male spigot of a conventional cable gland.

The externally screw threaded male spigot is made to comply with any applicable regulations or specifications such as may, for example, apply to explosion proof electrical installations for use in explosive atmospheres. In such an instance the length of a screw threaded connection or at least the number of screw threads to be inter-engaged may be prescribed by regulation or standard or it may require a predetermined length or number of threads.

In any event, for the purposes of the present invention, the length of the externally screw threaded male spigot is selected to accommodate also a screw thread of a locknut (14) that cooperates with the screw thread on the male spigot whilst leaving usable screw thread on the male spigot that has a length at least one thread pitch longer than is required for satisfying a design requirement or specification.

The elbow has interposed between the male screw thread and the elbow itself a right circular cylindrical surface (15) located opposite a cooperating sealing surface (16) of an integral axially extending annular extension (17) to the locknut with a sealing ring in the form of an O-ring (18) being interposed between the two surfaces. The cylindrical surface on the elbow has a groove (19) that partially accommodates and axially locates the O-ring that seals against a base (25) (see FIG. 5) of the groove that forms the sealing surface associated with the cylindrical surface (15) and projects radially beyond the cylindrical surface in which the groove is located.

The sealing surface on the annular extension to the locknut is a smooth inwardly directed right circular cylindrical surface engaged by the sealing ring. As will be quite apparent to those of ordinary skill in the art, the length of the sealing surface of the annular extension to the locknut must be sufficient to enable the elbow to be rotated by a full 360° about the axis (A) of the screw threaded male spigot in order to provide for full angular adjustability of the elbow so that it can be positioned with the axis (B) of the female screw threaded socket directed as may be required.

A 360° rotation of the elbow means an axial movement of the elbow of one pitch of the screw thread and following such rotation, the seal of the O-ring must still effectively engage the sealing surface of the annular extension. The significance of this will become more apparent from what follows in regard to the operative installation of an elbow as described above. The O-ring thus provides effective ingress protection against moisture and other unwanted fluids.

The end of the cylindrical surface (15) on the elbow itself remote from the free end of the externally screw threaded male spigot is defined by an outwardly directed integral abutment flange (20) that cooperates with the free end (21) of the annular extension to the locknut remote from the screw threaded male spigot in the fully retracted terminal position of the locknut.

In order to facilitate installation of an elbow as described above, the elbow has two oppositely directed flat engagement surfaces (22) (see FIGS. 2, 3 and 6) on opposite sides thereof for engagement by jaws of a tool such as a suitable spanner having jaws whereby the elbow can be rotated about the axis of the screw threaded male spigot.

The tubular elbow described above can be made to be compact, adjustable and simple to manufacture using available manufacturing facilities and without any complex or costly processes being involved. The elbow will most likely be made of a suitable metal material that may optionally be enclosed within a suitable plastics material, especially a fibre reinforced dough moulding compound or other suitable plastics material. It is, however, within the scope of the invention that the elbow itself could be made of a suitably reinforced plastics or other material.

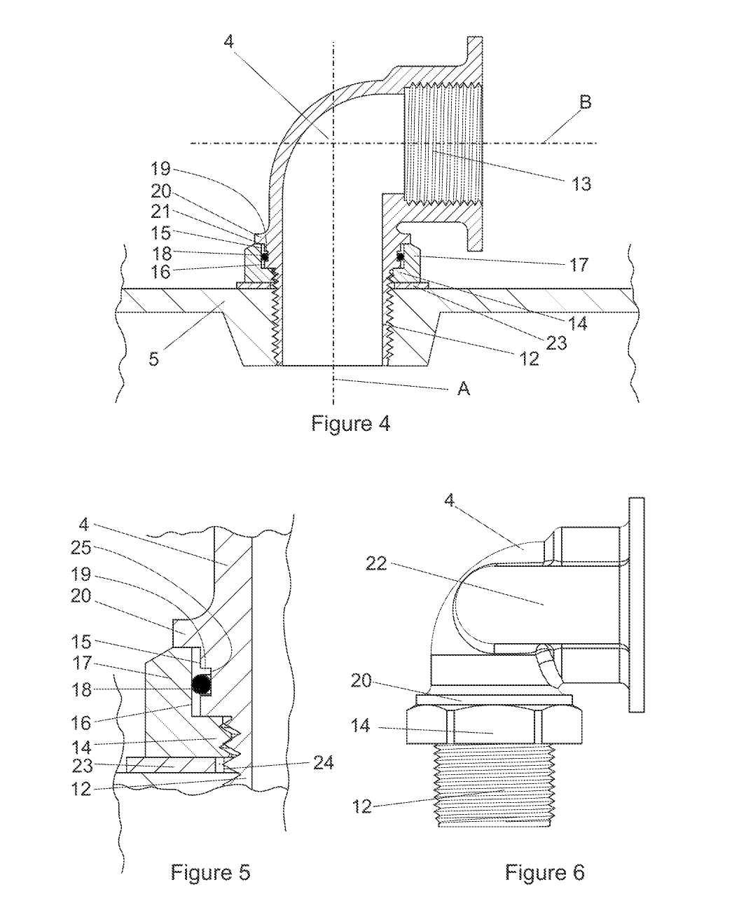

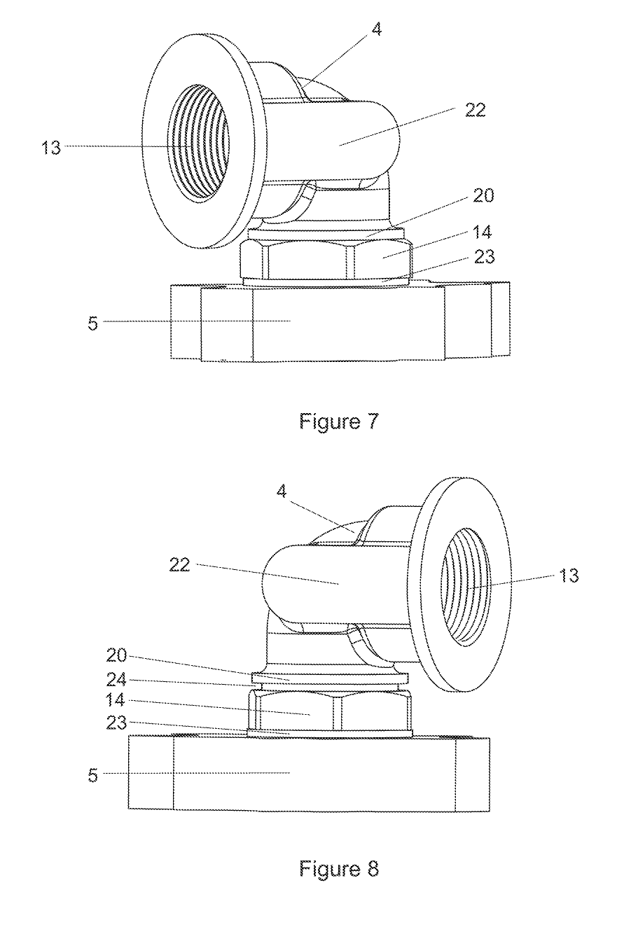

The tubular elbow described above is fitted by first fully tightening the locknut against the integral abutment flange (20) of the elbow as shown in FIGS. 4, 6 and 7 and the assembly may then be fully tightened into a junction box or housing of any other equipment to a position exemplified in FIG. 7 with a standard sealing washer (23) against the face of the nut provides the final IP protection. The elbow may then be released by rotating it about the axis of the screw threaded male spigot by no more than 360° until the axis of the screw threaded female socket extends in the desired direction that for illustrative purposes is shown in FIG. 8. The locknut is then tightened against the junction box or housing of any other equipment to secure it in that position by way of the sealing washer. The result of this is that a space (24) develops between the abutment flange (20) and the adjacent end of the extension to the locknut, as shown in FIG. 8.

As a general rule, the elbow is made such that if it is adjusted by more than one thread pitch, the O-ring will start to become exposed and will thus provide a visual indication that the elbow may not have enough threads engaged to satisfy the requirements for use in explosive atmospheres, for example.

As an example, if the externally screw threaded male spigot has a screw thread pitch of 1.5 mm when the elbow is rotated by a full 360° the nut will move axially relative to the screw threaded male spigot of the elbow by 1.5 mm and the O-ring must remain properly engaged in all angular positions. This is sufficient to enable the female socket of the elbow to be directed in any direction and the design is such that the amount of thread still engaged in the junction box or housing of any other equipment meets all of the requirements.

The seal provided by the O-ring prevents the ingress of moisture along the threads and a standard sealing washer against the face of the nut provides final ingress protection. As indicated above, that standard sealing washer may be held captive relative to the screw threaded male spigot and that may be achieved simply by dimensioning the aperture through the washer so that the screw thread interferes with it to a satisfactory extent, as indicated by dotted line (24) in FIG. 5.

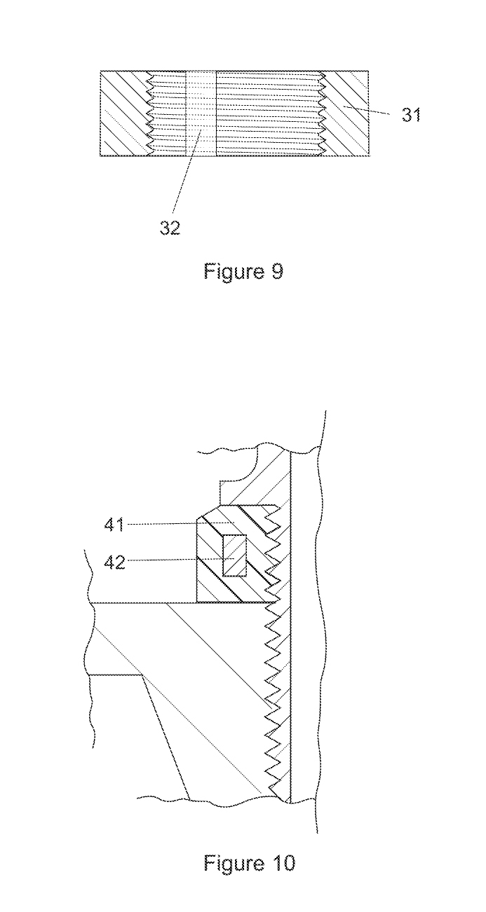

Turning now to the embodiment of the second variation of the invention that is illustrated in FIG. 9, the extension to the locknut described above together with the O-ring are omitted. In their place there is employed a locknut (31) in which the seal is in the form of an axially extending patch (32) of polyester or other suitable deformable material that extends over a limited circumferential portion of the thread and typically along its entire length. The deformable material is resilient; has high strength and may be one that is used in normal locknuts employing such a patch that have a dedicated locknut application. Suitable locknuts are considered to be those sold under the trade mark Poly-Lok® by the company Long-Lok Fasteners Corporation of Los Angeles in the USA. The patch size and location may be varied according to requirements.

A locknut of this type exhibits a thread seal in which the patch acts as a dam to prevent liquid leakage along any of the thread helixes over which the patch extends. The patch provides excellent sealing properties between the load bearing and non-load bearing flanks of the mating threads or along any small gaps at the root or crest of the threads. The patch formulation is impervious to water and many other fluids.

FIG. 10 illustrates an embodiment of the third variation of the invention in which the entire locknut (41) that is appropriately strong and deformable such that its screw thread sealingly engages the screw thread of the male spigot. The plastics material may optionally be reinforced and may for example be a suitable grade of nylon or the like. In any event it is important that it sealingly engages the male spigot screw thread. Such a plastic locknut may be additionally reinforced by one or more endless reinforcing rings (42) moulded into and embedded within the plastics material. Also, in such an instance, depending on the material from which the locknut is made, the sealing washer that would mostly otherwise be necessary to prevent the ingress of moisture or other unwanted fluid may conceivably be omitted, as illustrated in FIG. 11. The material from which the locknut is made can therefore be selected to create a seal with an engaged surface of a junction box thereby enabling the sealing washer to be omitted.

Numerous variations may be made to the embodiments of the invention described above without departing from the scope hereof.

Throughout the specification and claims unless the content requires otherwise the word ‘comprise’ or variations such as ‘comprises’ or ‘comprising’ will be understood to imply the inclusion of a stated integer or group of integers but not the exclusion of any other integer or group of integers.

1. An angularly adjustable tubular elbow comprising an elbow having an externally screw threaded male spigot at one end and a correspondingly screw threaded female socket at the other end and wherein a locknut cooperates with the screw thread on the male spigot leaving usable screw thread on the male spigot that has a length at least one thread pitch longer than is required for satisfying a specification when the locknut is screwed fully onto the male spigot to a terminal position, the locknut having an end surface nearer a free end of the male spigot that is suitable for sealing against an outer surface of a junction box either directly or indirectly by way of a sealing washer and wherein a seal on the locknut or male spigot or both serves to seal the screw thread of the male spigot and the locknut against the passage of moisture or other fluids along the thread.

2. An angularly adjustable tubular elbow as claimed in claim 1 in which the locknut has a coaxial annular extension extending in a direction away from the free end of the screw threaded male spigot and the elbow has, interposed between the male spigot screw thread and the elbow itself, a cylindrical surface directed radially outwards and coaxial with the male spigot with the cylindrical surface being located radially opposite a cooperating sealing surface on the annular extension to the locknut with the seal being in the form of a sealing ring interposed between two sealing surfaces to effectively seal the surfaces together for at least one full turn of the locknut from its terminal position.

3. An angularly adjustable tubular elbow as claimed in claim 2 in which the cylindrical surface on the elbow includes a groove partially accommodating the sealing ring that projects radially beyond the adjacent cylindrical surface in which the groove is located.

4. An angularly adjustable tubular elbow as claimed in claim 3 in which the sealing ring is in the form of an O-ring that seals against the base of the groove.

5. An angularly adjustable tubular elbow as claimed in claim 2 in which the sealing surface on the annular extension to the locknut is a smooth inwardly directed right circular cylindrical surface engaged by the sealing ring.

6. An angularly adjustable tubular elbow as claimed in claim 1 in which the seal is in the form of an axially extending patch of deformable material that extends over a limited circumferential portion of the thread and acts as a dam to prevent liquid leakage along the thread helix.

7. An angularly adjustable tubular elbow as claimed in claim 1 in which the entire locking nut is made of an optionally reinforced plastic material such that its thread sealingly engages the male spigot screw thread.

8. An angularly adjustable tubular elbow as claimed in claim 7 in which the plastic locking nut is reinforced by one or more endless reinforcing rings moulded into and embedded within the plastics material.

9. An angularly adjustable tubular elbow as claimed in claim 7 in which the material from which the locknut is made is selected to create a seal with an engaged surface of a junction box.

10. An angularly adjustable tubular elbow as claimed in claim 1 in which the elbow has two oppositely directed engagement surfaces on sides thereof for engagement by jaws of a tool whereby the elbow can be rotated about the axis of the screw threaded male spigot.

11. An angularly adjustable tubular elbow as claimed in claim 1 in which the screw threaded male spigot is complementary to a screw thread or fixed nut associated with a junction box and the screw threaded female socket is complementary to the external screw threads on a screw threaded male spigot of a cable gland for fitment to the junction box by way of the tubular elbow.

12. An angularly adjustable tubular elbow as claimed in claim 1 in which a sealing washer is held captive relative to the locknut or male spigot for location, in use, between the locknut and an outer surface of a junction box.

13. An angularly adjustable tubular elbow as claimed in claim 1 in combination with an electrical junction box to which the elbow is fitted.
